(19) United States
(12) Patent Application Publication
(10) Pub. No.: US 2026/0168966 A1
(43) Pub. Date: Jun. 18, 2026

(54) DEFECT INSPECTION SYSTEM AND DEFECT INSPECTION METHOD

(71) Applicant: Hitachi Power Solutions Co., Ltd., Ibaraki (JP)

(72) Inventors: Kaoru SAKAI, Tokyo (JP); Masamichi UMEDA, Ibaraki (JP)

(21) Appl. No.: 19/126,271

(22) PCT Filed: Nov. 20, 2023
(86) PCT No.: PCT/JP2023/041635

§ 371 Date: May 1, 2025

(30) Foreign Application Priority Data
Nov. 30, 2022 (JP) 2022-191945

(51) Int. Cl. G01N 29/06; G01N 23/18; G01N 29/44

(52) U.S. Cl. CPC G01N 29/069; G01N 23/18; G01N 29/4427; G01N 29/4436; G01N 29/4445; G01N 2223/6116; G01N 2223/6462; G01N 2291/2697

(57) ABSTRACT

Provided is a defect inspection system and the like for inspecting presence or absence of a defect in an inspection object in a die unit. The defect inspection system includes an image generation unit configured to acquire an inspection target image by irradiating an inspection object formed by bonding a die to a semiconductor wafer with ultrasonic waves or X-rays, a defect detection unit configured to detect a defect region by comparing a reference image indicating an image in which the die is appropriately bonded to the semiconductor wafer with the acquired inspection target image, and a defect classification unit configured to determine presence or absence of a defect in a die unit by analyzing the defect region with reference to design information of the die.

### TECHNICAL FIELD

The present invention relates to a defect inspection system and the like.

### BACKGROUND ART

As a technique for inspecting presence or absence of a defect based on an image of an inspection object, for example, there is a technique disclosed in PTL 1. That is, PTL 1 discloses that “brightness of an image of an inspection object is compared with brightness of a reference image to calculate defect accuracy, and the calculated defect accuracy is compared with a created multi-value mask to detect a defect”.

### CITATION LIST

### Patent Literature

PTL 1: JP2017-72501A

### SUMMARY OF INVENTION

### Technical Problem

For example, in a case where a plurality of dies arranged regularly are bonded to a semiconductor wafer as an inspection object, it is difficult to inspect the presence or absence of a defect in a die unit in the technique disclosed in PTL 1, and there is room for improvement.

Therefore, an object of the invention is to provide a defect inspection system and the like for inspecting the presence or absence of a defect in an inspection object in a die unit.

### Solution to Problem

In order to solve the above problem, the defect inspection system according to the invention includes an inspection image acquisition unit configured to acquire an inspection target image by irradiating an inspection object formed by bonding a die to a semiconductor wafer with ultrasonic waves or X-rays, a defect region detection unit configured to detect a defect region by comparing a reference image indicating an image in which the die is appropriately bonded to the semiconductor wafer with the acquired inspection target image, and a defect analysis unit configured to determine presence or absence of a defect in a die unit by analyzing the defect region with reference to design information of the die.

### Advantageous Effects of Invention

According to the invention, it is possible to provide a defect inspection system and the like for inspecting the presence or absence of a defect in an inspection object in a die unit.

### BRIEF DESCRIPTION OF DRAWINGS

FIG. 1 is a diagram illustrating a defect inspection system according to a first embodiment.

FIG. 2 is a configuration diagram illustrating the defect inspection system according to the first embodiment.

FIG. 3 is a diagram illustrating types of defects in an inspection object in the defect inspection system according to the first embodiment.

FIG. 4 illustrates an example of an image of a bonding surface of the inspection object in the defect inspection system according to the first embodiment.

FIG. 5A is an image illustrating an example of a reference image used in the defect inspection system according to the first embodiment.

FIG. 5B is an image illustrating an example of die design information used in the defect inspection system according to the first embodiment.

FIG. 6 is a flowchart related to processing of the defect inspection system according to the first embodiment.

FIG. 7 illustrates an example of an image for each defect type in the defect inspection system according to the first embodiment.

FIG. 8 is an example of an image illustrating a detection result of a defect in the inspection object in the defect inspection system according to the first embodiment.

FIG. 9 is a diagram related to a detection result in the case of incomplete bonding which is a type of die defect in the defect inspection system according to the first embodiment.

FIG. 10 is a diagram illustrating a defect inspection system according to a second embodiment.

FIG. 11 is a diagram related to processing of an image processing unit provided in the defect inspection system according to the second embodiment.

FIG. 12 is a plan view illustrating an inspection object in a defect inspection system according to a third embodiment.

FIG. 13 is a diagram related to processing of an image processing unit provided in the defect inspection system according to the third embodiment.

FIG. 14 is a diagram illustrating a result obtained by comparing luminance of each pixel of a reference image and each pixel of a die image according to a comparative example.

### DESCRIPTION OF EMBODIMENTS

### First Embodiment

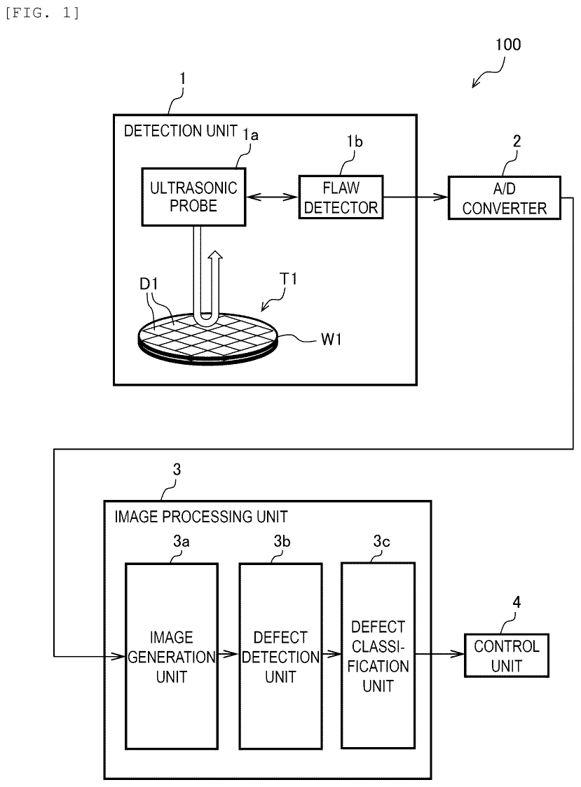

FIG. 1 is a diagram illustrating a defect inspection system 100 according to a first embodiment.

The defect inspection system 100 illustrated in FIG. 1 is a system for inspecting the presence or absence of a defect in an inspection object T1. The defect inspection system 100 also has a function of specifying a type of a defect when there is a defect in the inspection object T1. In the first embodiment, for example, defect inspection for the inspection object T1 having a configuration in which a plurality of dies D1 arranged in a predetermined manner are bonded (die-to-wafer bonded) to a semiconductor wafer W1 will be described. The “die” is a chip-shaped semiconductor in which a predetermined circuit is formed.

The inspection object T1 illustrated in FIG. 1 is a hybrid bonding semiconductor wafer in which an electrode formed on a surface of the semiconductor wafer W1 is bonded to an electrode formed on a surface of the die D1. Such a hybrid bonding semiconductor wafer is formed by heating a copper electrode on the surface of the semiconductor wafer W1 and a copper electrode on the surface of the die D1 in a state where the copper electrodes face each other. In the example of FIG. 1, a plurality of rectangular dies D1 are bonded to a surface of a disk-shaped semiconductor wafer W1 in a state where the dies D1 are arranged in rows and columns. Although a copper electrode portion of the semiconductor wafer W1 and a copper electrode portion of the die D1 are slightly recessed, when the semiconductor wafer W1 and the die D1 are heated in a state of being pressure-bonded to each other, the copper electrodes are thermally expanded and further mutually diffused to be bonded. A method of achieving high integration of circuits by bonding the semiconductor wafer W1 and the die D1 in this manner is referred to as hybrid bonding.

Among the large number of dies D1 bonded to the semiconductor wafer W1, there may be a die bonded in a state of being inclined relative to the surface of the semiconductor wafer W1 or a die bonded in a deflected state. Further, there may be a case where the die D1 is not present at a portion to be bonded on the semiconductor wafer W1. Therefore, in the first embodiment, the defect inspection system 100 specifies a type of such a defect (referred to as a “die defect”) in a die unit.

As illustrated in FIG. 1, the defect inspection system 100 includes a detection unit 1, an A/D converter 2, an image processing unit 3, and a control unit 4. The detection unit 1 irradiates the inspection object T1 with ultrasonic waves and generates a predetermined reflection intensity signal based on reflected waves. As illustrated in FIG. 1, the detection unit 1 includes an ultrasonic probe 1a and a flaw detector 1b. The ultrasonic probe 1a irradiates the inspection object T1 with ultrasonic waves based on a pulse signal from the flaw detector 1b, and further receives reflected waves from the inspection object T1.

The ultrasonic waves propagating inside the inspection object T1 are reflected by a boundary surface having a different acoustic impedance. Since an intensity of the reflected waves varies depending on the presence or absence of a defect in the inspection object T1, a defect in the inspection object T1 can be visualized by imaging a reflection intensity signal. In particular, since most of the ultrasonic waves are reflected at a portion where a gap is present on a bonding surface between the die D1 and the semiconductor wafer W1, a defect such as peeling of the die D1 can be detected with high sensitivity.

The flaw detector 1b outputs a pulse signal to the ultrasonic probe 1a to cause the ultrasonic probe 1a to emit ultrasonic waves toward the inspection object T1. The flaw detector 1b converts the reflected waves received by the ultrasonic probe 1a into a predetermined reflection intensity signal.

The A/D converter 2 converts the reflection intensity signal (analog signal) input from the flaw detector 1b into predetermined waveform data (digital signal). The image processing unit 3 inspects the presence or absence of a defect in the inspection object T1 and specifies a type of the defect based on the waveform data input from the A/D converter 2. As illustrated in FIG. 1, the image processing unit 3 includes an image generation unit 3a (inspection image acquisition unit), a defect detection unit 3b (defect region detection unit), and a defect classification unit 3c (defect analysis unit).

The image generation unit 3a generates image data of a bonding surface in the inspection object T1 based on the waveform data input from the A/D converter 2. Specifically, the image generation unit 3a extracts a maximum value of a reflection intensity from the waveform data and further converts the maximum value into a predetermined luminance value to generate image data of the bonding surface in the inspection object T1. That is, the image generation unit 3a (inspection image acquisition unit) irradiates the inspection object T1 formed by bonding the die D1 to the semiconductor wafer W1 with ultrasonic waves (or X-rays) to acquire an inspection target image.

The defect detection unit 3b (defect region detection unit) detects a defect region by comparing a reference image indicating an image in which the die D1 is appropriately bonded to the semiconductor wafer W1 with the acquired inspection target image.

The defect classification unit 3c (defect analysis unit) analyzes the defect region with reference to die design information (design information) of the die D1 to determine the presence or absence of a defect in a die unit. In addition, the defect classification unit 3c generates data related to a defect type and an observation image of the bonding surface, and outputs the data to the control unit 4.

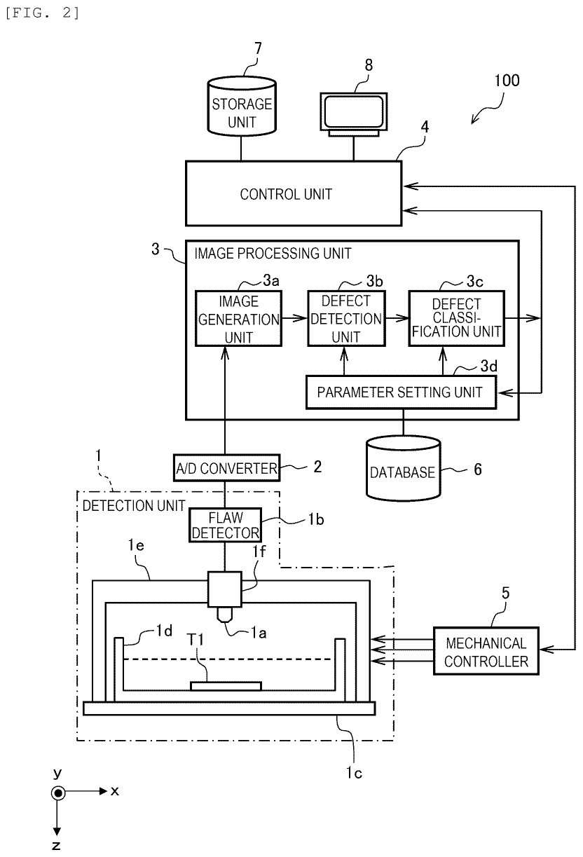

The control unit 4 is, for example, a microcomputer, and includes a random access memory (RAM) that is a volatile storage element, a read only memory (ROM) that is a nonvolatile storage element, and a central processing unit (CPU) that performs a predetermined calculation. A program stored in the ROM is read and loaded in the RAM, and the CPU executes various processing. The control unit 4 has a function of controlling the detection unit 1, the A/D converter 2, and the image processing unit 3 in addition to a function of displaying data output from the defect classification unit 3c on a display device 8 (see FIG. 2).

FIG. 2 is a configuration diagram illustrating the defect inspection system 100.

The detection unit 1 illustrated in FIG. 2 includes a scanner table 1c, a water tank 1d, a scanner 1e, and a holder 1f in addition to the ultrasonic probe 1a and the flaw detector 1b. The scanner table 1c is a horizontal base on which the water tank 1d and the scanner 1e are placed. The water tank 1d is a container for immersing the inspection object T1 in water (the water surface is indicated by a broken line in FIG. 2), and is placed on the scanner table 1c. The inspection object T1 is placed on the bottom of the water tank 1d, and water is stored up to a predetermined position higher than the inspection object T1. The water is a medium for propagating ultrasonic waves from the ultrasonic probe 1a toward the inspection object T1. As described above, the inspection object T1 is obtained by bonding a plurality of dies D1 (see FIG. 1) to the semiconductor wafer W1 (see FIG. 1).

The scanner 1e is a device for moving the ultrasonic probe 1a in an x-axis direction, a y-axis direction, and a z-axis direction, and is installed on the scanner table 1c across the water tank 1d. The holder 1f holds the ultrasonic probe 1a. The ultrasonic probe 1a emits ultrasonic waves in a predetermined measurement range while being moved in the x-axis direction and the y-axis direction (horizontal directions) by the scanner 1e. As a result, two-dimensional image data (image data of a bonding surface of the inspection object T1) in a predetermined measurement range is generated by the image generation unit 3a.

The detection unit 1 includes a parameter setting unit 3d in addition to the configuration described above. The parameter setting unit 3d reads, from a database 6, a parameter such as a measurement condition input by a user operating an input device (not illustrated), and outputs the parameter to the defect detection unit 3b or the defect classification unit 3c.

The defect inspection system 100 further includes a mechanical controller 5, the database 6, a storage unit 7, and the display device 8. The mechanical controller 5 moves the scanner 1e in the x-axis direction, the y-axis direction, and the z-axis direction. The database 6 stores a parameter such as a measurement condition when a defect of the inspection object T1 is inspected.

The storage unit 7 stores a processing result of the image processing unit 3 or the control unit 4. For example, a type of a defect detected by the image processing unit 3 is stored in the storage unit 7 in association with image data of the defect. The display device 8 displays a predetermined processing result of the image processing unit 3 or the control unit 4. For example, in addition to an image and the number of defects of the inspection object T1, a position and a dimension of a defect are displayed on the display device 8.

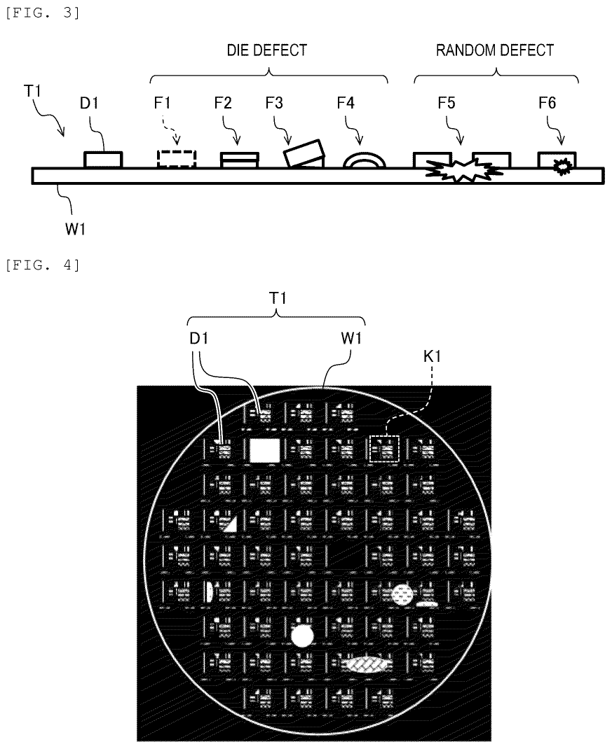

FIG. 3 is a diagram illustrating types of defects of the inspection object T1.

A left end of FIG. 3 illustrates a state where the die D1 is properly bonded to the semiconductor wafer W1. The types of defects of the inspection object T1 are roughly classified into a die defect and a random defect. The “die defect” is a defect generated in a die unit due to a bonding error between the die D1 and the semiconductor wafer W1. As examples of such a “die defect”, FIG. 3 illustrates a defect F1 of “no die”, a defect F2 of “die floating”, a defect F3 of “incomplete bonding die”, and a defect F4 of “die deflection”.

The defect F1 of “no die” is a defect when the die D1 is missing in the semiconductor wafer W1. That is, the defect F1 of “no die” is a defect when the die D1 is not present at an original position on the semiconductor wafer W1. The defect F2 of “die floating” is a defect when the die D1 is bonded in a state of floating from the semiconductor wafer W1. The defect F3 of “incomplete bonding” is a defect when a part of the die D1 is not bonded to the semiconductor wafer W1, when a bonding position of the die D1 on the semiconductor wafer W1 is not appropriate, or when there is a gap between the die D1 and the semiconductor wafer W1. A case where at least a part of the die D1 is bonded to a surface of the semiconductor wafer W1 in an inclined state is also included in the defect F3 of “incomplete bonding”. The defect F4 of “die deflection” is a defect when the die D1 is bonded to the semiconductor wafer W1 in a deflected state (distorted state). In addition, it is also possible to specify a type of a die defect such as the presence of a foreign substance between the die D and the semiconductor wafer W1. These die defects are bonding defects generated in a die unit specific to die-to-wafer bonding.

The “random defect” described above is a defect that may randomly occur between the semiconductor wafer W1 and the die D1. As an example of such a “random defect”, FIG. 3 illustrates a defect F5 of “void” and a defect F6 of “crack”. The defect F5 of “void” is a relatively large gap that occurs over the plurality of dies D1. The defect F6 of “crack” is a minute gap occurring in a bonding surface between the semiconductor wafer W1 and the die D1. These two types of defects (random defects) may occur in bonding forms other than the die-to-wafer bonding, and may also occur in the die-to-wafer bonding. The defect classification unit 3c (defect analysis unit: see FIG. 1) also has a function of determining the presence or absence of a defect (random defect) caused by a void or a crack in addition to a defect in a die unit.

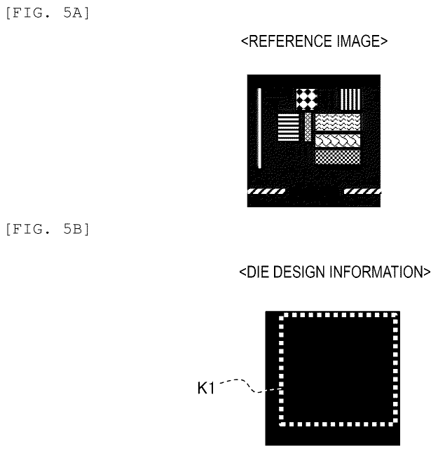

FIG. 4 illustrates an example of an image of a bonding surface of the inspection object T1.

In the example of FIG. 4, an image of a bonding surface in a case where the plurality of rectangular dies D1 are bonded to the disk-shaped semiconductor wafer W1 in a state where the plurality of rectangular dies D1 are arranged in rows and columns is illustrated. A region surrounded by a broken line frame K1 in FIG. 4 corresponds to one die D1. It is assumed that the plurality of dies D1 bonded to one semiconductor wafer W1 have the same circuit structure. In the example of FIG. 4, in addition to a white rectangular region, there are circular, elliptical, and triangular regions. A defect type is specified based on a circuit pattern of the die D1 in addition to a position, a size, a shape, and luminance of these regions.

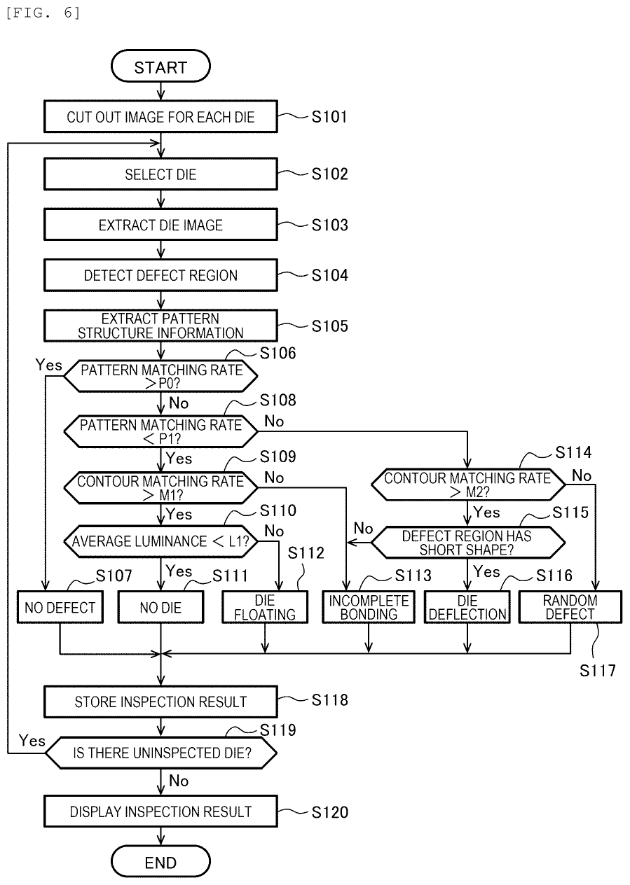

FIG. 5A is an image illustrating an example of a reference image.

FIG. 5A illustrates a simplified circuit pattern of the die D1 (see FIG. 4). The “reference image” illustrated in FIG. 5A is a partial image in a state where the die D1 is appropriately bonded to the semiconductor wafer W1. The reference image may be generated by statistical processing based on an image of the inspection object T1 (see FIG. 4). Examples of such statistical processing include a method using μ_brightness which is a statistical feature.

When μ_brightness is used, the defect inspection system 100 performs a calculation of the following Formula (1) for a position (x, y) of each pixel of the plurality of die images included in an image of the inspection object T1. A “die image” is an image of a region (die region) corresponding to one die D1 included in the inspection object T1. For example, a partial image surrounded by the broken line frame K1 in FIG. 4 is a “die image”. d1 (x, y) to dN (x, y) included in Formula (1) are luminance values at a position (x, y) in die images. “maxCounter” is a filter used when a most frequent luminance value is obtained based on the luminance values d1 (x, y) to dN (x, y). The defect inspection system 100 generates a reference image G (x, y) based on the most frequent luminance value at the position (x, y) in a die image.

$$\begin{matrix}[ Math . 1 ] & \\ G ( x , y ) = μ\_brightness ( x , y ) ( = max Counter ( d 1 ( x , y ) , d 2 ( x , y ) , … , dN ( x , y ) ) & ( 1 )\end{matrix}$$

Such data of the reference image G (x, y) is used when a die image and the reference image are compared in defect inspection. The data of the reference image G (x, y) is stored in the database 6 (see FIG. 2) in association with a type of the die D1.

FIG. 5B is an image illustrating an example of die design information.

The “die design information” is data including pattern structure information of a die region corresponding to one die D1 (see FIG. 4) in addition to a position, a shape, and luminance of the die region. Here, the “position” of the die region is data indicating a position of the die region (a region in the broken line frame K1 in FIG. 5B) relative to one image (an image in FIG. 5B) when an image of the inspection object T1 (see FIG. 4) is divided for each predetermined number of pixels in a vertical direction and a horizontal direction. Since a portion other than the die D1 may be included in an image obtained by regularly cutting out the die D1 one by one from the image of the inspection object T1 (see FIG. 4), the relative “position” of the die region is specified.

The “shape” of the die region included in the die design information is a shape of the broken line frame K1 illustrated in FIG. 5B. The “pattern structure information” included in the die design information is information indicating a circuit pattern of the die region. For example, design data of the die D1 is used as such pattern structure information. The pattern structure information may be generated based on a texture feature of the reference image (see FIG. 5A). Such a texture feature includes a pattern pitch, a pattern luminance value, and the like in addition to a density and an orientation of a predetermined pattern included in the reference image.

In addition, the pattern structure information of the die region may be represented by a predetermined luminance gradient code. That is, for each pixel of the reference image or a die image, a 5-bit luminance gradient codes of 0 to 16 may be generated by searching for a direction in which the luminance gradient is maximized in surrounding eight neighboring pixels. That is, a circuit pattern of the die D1 represented by a 5-bit code is the luminance gradient code. The die design information including such pattern structure information is used for defect inspection of the inspection object T1.

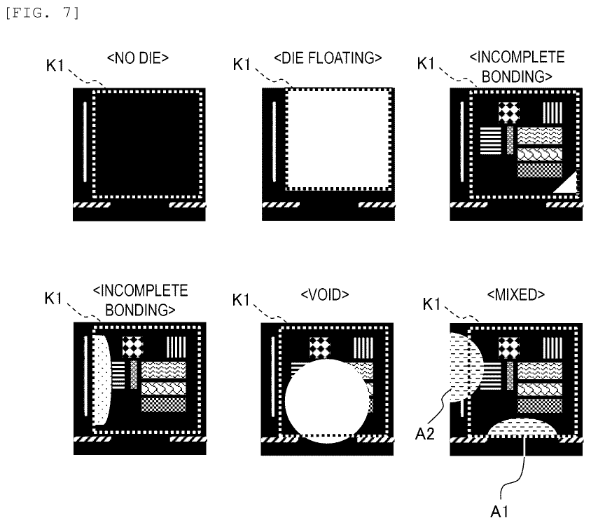

FIG. 6 is a flowchart related to processing of the defect inspection system 100 (also see FIG. 1 as appropriate).

At the time of “START” in FIG. 6, it is assumed that image data (inspection target image) when the inspection object T1 is irradiated with ultrasonic waves is generated by the image generation unit 3a (inspection image acquisition processing).

In step S101, the defect inspection system 100 cuts out an image for each die D1 from an image of the inspection object T1. For example, the defect inspection system 100 cuts out rectangular images including the dies D1 in a one-to-one manner by dividing the image of the inspection object T1 illustrated in FIG. 4 into a predetermined number of pixels in the vertical direction and the horizontal direction. Identification information of the die D1 is associated with such a rectangular image.

In step S102, the defect inspection system 100 selects one of the plurality of dies D1 included in the inspection object T1.

In step S103, the defect inspection system 100 extracts a die image from the image including the die D1 selected in step S102. As described above, the “die image” is an image of a die region corresponding to one die D1.

In step S104, the defect inspection system 100 causes the defect detection unit 3b to detect a defect region from the die image. That is, the defect inspection system 100 detects a defect region by comparing a predetermined reference image with an inspection target image (defect region detection processing). Accordingly, in the die image, a group of pixels having luminance different from that of pixels of the reference image is detected as a predetermined defect region.

In step S105, the defect inspection system 100 extracts pattern structure information. For example, the defect inspection system 100 extracts the pattern structure information of a die image by representing a texture feature of the die image extracted in step S103 with a predetermined luminance gradient code. Similarly, pattern structure information of the reference image (see FIG. 5A) is also extracted.

In step S106, the defect inspection system 100 determines whether a pattern matching rate (matching rate) of the die image relative to the reference image is higher than a predetermined value P0. The “pattern matching rate” is a numerical value indicating a degree that a circuit pattern of the die image matches a circuit pattern of the reference image. For example, the pattern matching rate is calculated based on whether luminance gradient codes at corresponding positions in the reference image and the die image match each other.

When the pattern matching rate is higher than the predetermined value P0 in step S106 (S106: Yes), the defect inspection system 100 proceeds the processing to step S107.

In step S107, the defect inspection system 100 causes the defect classification unit 3c to determine “no defect”. That is, the defect inspection system 100 determines that there is no defect on a bonding surface between the semiconductor wafer W1 and the die D1 selected in step S102.

When the pattern matching rate is equal to or less than the predetermined value P0 in step S106 (S106: No), although not illustrated in FIG. 6, the defect classification unit 3c determines that there is a defect on the bonding surface between the die D1 and the semiconductor wafer W1, and the processing proceeds to step S108.

In step S108, the defect inspection system 100 determines whether the pattern matching rate of the die image relative to the reference image is less than a predetermined value P1 (first predetermined value). The predetermined value P1 is a threshold of the pattern matching rate, and is set in advance as a threshold lower than the predetermined value P0 used in step S106.

In step S108, when the pattern matching rate of the die image relative to the reference image is less than the predetermined value P1 (S108: Yes), the defect inspection system 100 proceeds the processing to step S109.

In step S109, the defect inspection system 100 determines whether a contour matching rate between a flat luminance region and a die region of the die image is higher than a predetermined value M1 (second predetermined value). The “contour matching rate” is a numerical value indicating a degree that positions of contours of two shapes substantially match each other.

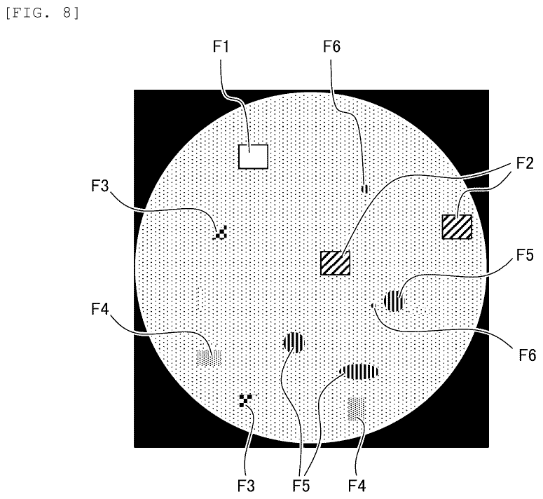

For example, in an image of “no die” illustrated in FIG. 7, substantially all pixels in the broken line frame K1 are black. For example, in an image of “die floating” illustrated in FIG. 7, substantially all pixels in the broken line frame K1 are white. In this manner, a region in which a luminance difference between adjacent pixels in a die image is equal to or less than a predetermined value is a “flat luminance region”. The “flat luminance region” substantially coincides with a defect region on the bonding surface between the die D1 and the semiconductor wafer W1.

In step S109 of FIG. 6, when the contour matching rate between the flat luminance region and the die region of the die image is higher than the predetermined value M1 (S109: Yes), the defect inspection system 100 proceeds the processing to step S110.

In step S110, the defect inspection system 100 determines whether average luminance of a defect region (flat luminance region) included in the die image is less than a predetermined value L1 (third predetermined value). When the average luminance of the defect region is less than the predetermined value L1 (S110: Yes), the defect inspection system 100 proceeds the processing to step S111.

In step S111, the defect inspection system 100 causes the defect classification unit 3c to determine that a defect type is “no die”. As described above, when the pattern matching rate (matching rate) of the circuit pattern of the die image relative to a normal circuit pattern of the die D1 is less than the predetermined value P1 (first predetermined value) (S108: Yes) and the following conditions are further satisfied, the defect classification unit 3c determines that a defect type is “no die”. That is, when the contour matching rate between a contour of the flat luminance region of the die image and a contour of the die image is higher than the predetermined value M1 (second predetermined value) (S109: Yes), and further the average luminance of the defect region is less than the predetermined value L1 (third predetermined value) (S110: Yes), the defect classification unit 3c determines that the die D1 is not present at an original position of the semiconductor wafer W1 (that is, “no die”) (S111).

FIG. 7 illustrates an example of an image for each defect type.

In “no die” illustrated in FIG. 7, since the die D1 is not present at a position to be bonded and a bonding surface that reflects ultrasonic waves does not exist, as a result, substantially the entire region of an image of a die region becomes black. In both “no die” and “die floating”, the contour matching rate (S109 in FIG. 6) is close to “1”, but the average luminance of a defect region is different (S110 in FIG. 6).

In step S110 of FIG. 6, when the luminance average value of the defect region is equal to or larger than the predetermined value L1 (S110: No), the defect inspection system 100 proceeds the processing to step S112.

In step S112, the defect inspection system 100 causes the defect classification unit 3c to determine that a defect type is “die floating”. That is, the defect classification unit 3c determines that most of the die D1 is floating from the semiconductor wafer W1. In the “die floating” illustrated in FIG. 7, since there is a gap between the die D1 and the semiconductor wafer W1, ultrasonic waves are reflected at an interface of the gap. As a result, substantially the entire region of an image of the die region becomes white (or gray).

In step S109 of FIG. 6, when the contour matching rate between the flat luminance region and the die region is equal to or less than the predetermined value M1 (S109: No), the defect inspection system 100 proceeds the processing to step S113.

In step S113, the defect inspection system 100 causes the defect classification unit 3c to determine that a defect type is “incomplete bonding”. That is, the defect classification unit 3c determines that the bonding of the die D1 to the semiconductor wafer W1 is incomplete. In “incomplete bonding” on an upper right side of FIG. 7, since bonding of a corner portion in the broken line frame K1 is incomplete, pixels of a triangular portion of the corner portion are white. In addition, in another “incomplete bonding” on a lower left side of FIG. 7, since bonding near a left end in the broken line frame K1 is incomplete, pixels of this portion are gray (dot display in FIG. 7).

In step S108 of FIG. 6, when the pattern matching rate is equal to or larger than the predetermined value P1 (S108: No), the defect inspection system 100 proceeds the processing to step S114.

In step S114, the defect inspection system 100 determines whether the contour matching rate between the flat luminance region and the die region of the die image is higher than a predetermined value M2 (fourth predetermined value). The predetermined value M2 is a threshold of a contour matching rate for distinguishing a die defect such as “incomplete bonding” (see FIG. 7) or “die deflection” (see FIG. 7) from other random defects, and is set in advance as a value lower than the predetermined value M1 in step S109.

In step S114, when the contour matching rate between the flat luminance region and the die region of the die image is higher than the predetermined value M2 (S114: Yes), the defect inspection system 100 proceeds the processing to step S115.

In step S115, the defect inspection system 100 determines whether a shape of a defect region (flat luminance region) is rectangular. When the shape of the defect region is rectangular (S115: Yes), the defect inspection system 100 proceeds the processing to step S116.

In step S116, the defect inspection system 100 causes the defect classification unit 3c to determine that a defect type is “die deflection”. That is, when the pattern matching rate (matching rate) of the circuit pattern of the die image relative to the normal circuit pattern of the die D1 is equal to or larger than the predetermined value P1 (first predetermined value) (S108: No) and the following conditions are further satisfied, the defect classification unit 3c determines that a defect type is “die deflection”. That is, when the contour matching rate between the contour of the flat luminance region of the die image and the contour of the die image is higher than the predetermined value M2 (fourth predetermined value) (S114: Yes), and further the shape of the defect region is rectangular (S115: Yes), the defect classification unit 3c determines that the die D1 is bonded to the semiconductor wafer W1 in a deflected state (S116). Although not particularly illustrated in FIG. 7, when the die D1 is deflected in the vertical direction or the horizontal direction, the defect region in the die image often has a rectangular shape.

When the defect region is not rectangular in step S115 (S115: No), the defect inspection system 100 proceeds the processing to step S115.

In step S115, the defect inspection system 100 causes the defect classification unit 3c to determine that a defect type is “incomplete bonding”. For example, in “mixed” on a lower right side of FIG. 7, a part of edges of a defect region A1 has an arc shape, and the remaining edges substantially coincide with a part of a broken line frame K (a contour of a die region). Therefore, it is determined that a defect type is “incomplete bonding” for the defect region A1.

In addition, in step S114 of FIG. 6, when the contour matching rate between the flat luminance region and the die region of the die image is equal to or less than the predetermined value M2 (S114: No), the defect inspection system 100 proceeds the processing to step S117.

In step S117, the defect inspection system 100 causes the defect classification unit 3c to determine that a defect type is a “random defect”. That is, the defect classification unit 3c determines that a predetermined random defect is present on the bonding surface between the die D1 and the semiconductor wafer W1. In “void” illustrated in FIG. 7, a circular void portion in the die image is white. Further, in “mixed” illustrated in FIG. 7, a void is present over a plurality of dies in a manner of including a defect region A2.

Although omitted in FIG. 6, when a plurality of defect regions are present in the die image, a defect type is specified for each defect region. In addition, “defect analysis processing” for determining the presence or absence of a defect in a die unit by analyzing a defect region with reference to the design information of the die D1 includes the processing of steps S105 to S117 in FIG. 6. Such “defect analysis processing” is executed by the defect classification unit 3c (see FIG. 1).

After executing the processing of step S107, S111, S112, S113, S116, or step S117 in FIG. 6, the defect inspection system 100 proceeds the processing to step S118. In step S118, the defect inspection system 100 stores an inspection result. That is, the defect inspection system 100 stores identification information of the die D1 selected in step S102 in the storage unit 7 (see FIG. 2) in association with a type and the like of a defect related to the die D1.

Next, in step S119, the defect inspection system 100 determines whether there is another uninspected die D1. When there is another uninspected die D1 (S119: Yes), the defect inspection system 100 returns the processing to step S102. When there is no other uninspected die D1 in step S119 (S119: No), the defect inspection system 100 proceeds the processing to step S120.

In step S120, the defect inspection system 100 causes the control unit 4 to display the inspection result on the display device 8 (see FIG. 2). For example, the control unit 4 assigns a predetermined label indicating a defect type to each defect, and displays a predetermined defect image on the image of the inspection object T1 in a superimposed manner by an identifiable display method such as color coding.

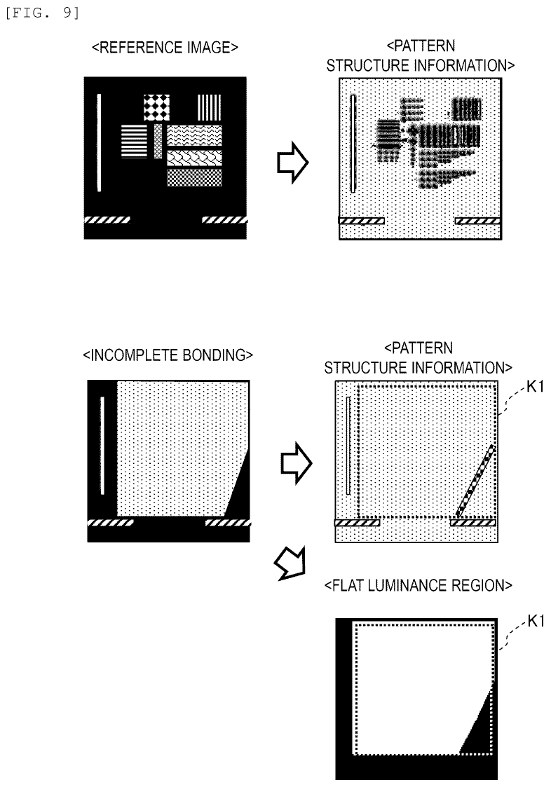

FIG. 8 is an example of an image illustrating a detection result of a defect in an inspection object.

The image in FIG. 8 is a display example of the inspection result when the image of the inspection object T1 illustrated in FIG. 4 is used. In the example of FIG. 8, a defect image of the defect F1 of “no die” is displayed in rectangular white. A defect image of the defect F2 of “die floating” is displayed in a hatched rectangle. In addition to the defect F3 of “incomplete bonding” and the defect F4 of “die deflection”, the defect F5 of “void” and the defect F6 of “crack” are identifiably displayed in a predetermined manner. As described above, based on a processing result of the defect classification unit 3c, the control unit 4 displays a predetermined defect image associated with a defect type of the defect region in a superimposed manner at a position of the defect region in the image of the inspection object T1. By viewing such an image, a user can grasp at a glance which type of defect occurs in which portion of the inspection object T1. These defect classification results are appropriately reflected in a change of a process condition such as a temperature condition when the die D1 and the semiconductor wafer W1 are heated.

FIG. 14 is a diagram illustrating a result obtained by comparing luminance of each pixel of a reference image and each pixel of a die image according to a comparative example.

In FIG. 14, pixels having a relatively small luminance difference from the reference image are indicated by dots. A pixel having high luminance (a portion recognized as a defect) relative to the reference image is indicated by white, and a pixel having low luminance (a portion recognized as a defect) relative to the reference image is indicated by black. In the comparative example on an upper side of FIG. 14, since luminance of a defect region is equal to luminance of a circuit pattern of the reference image, the circuit pattern portion is not detected as a defect. Further, in the comparative example on a lower side of FIG. 14, since a luminance difference from the reference image is large at a portion corresponding to a circuit pattern, a portion other than the circuit pattern is not detected as a defect. As described above, in a method for simply comparing the luminance of each pixel, it is difficult to detect a defect in a die unit such as “incomplete bonding” or “no die”.

On the other hand, in the first embodiment, defect types in the die unit are classified based on a position, a size, a shape, and luminance of a defect region in addition to the die design information. Accordingly, it is possible to detect a defect in a die unit such as “no die”, “die floating”, “die deflection”, or “incomplete bonding” with high accuracy.

FIG. 9 is a diagram related to a detection result in the case of incomplete bonding which is a type of die defect.

As illustrated in FIG. 9, the pattern structure information is extracted from the reference image, and another piece of pattern structure information is extracted from the die image (in the case of incomplete bonding). In the example of FIG. 9, since the matching rate of the pattern structure information in the broken line frame K1 (in a die region) is about 0%, it is determined that “there is a die defect”. Further, it is determined that shapes of lower right corner portions do not match each other based on a comparison between the flat luminance region (white region) extracted from the die image and the die region, and “incomplete bonding” is determined.

### Effects

According to the first embodiment, the defect inspection system 100 specifies a defect type in a die unit based on image data when the inspection object T1 is irradiated with ultrasonic waves. Accordingly, for example, since a type of die defect specific to die-to-wafer bonding can be specified, an administrator can appropriately change a process condition based on an inspection result. Therefore, the process condition can be improved at an early stage, and thus the yield in mass production of semiconductor products can be improved.

### Second Embodiment

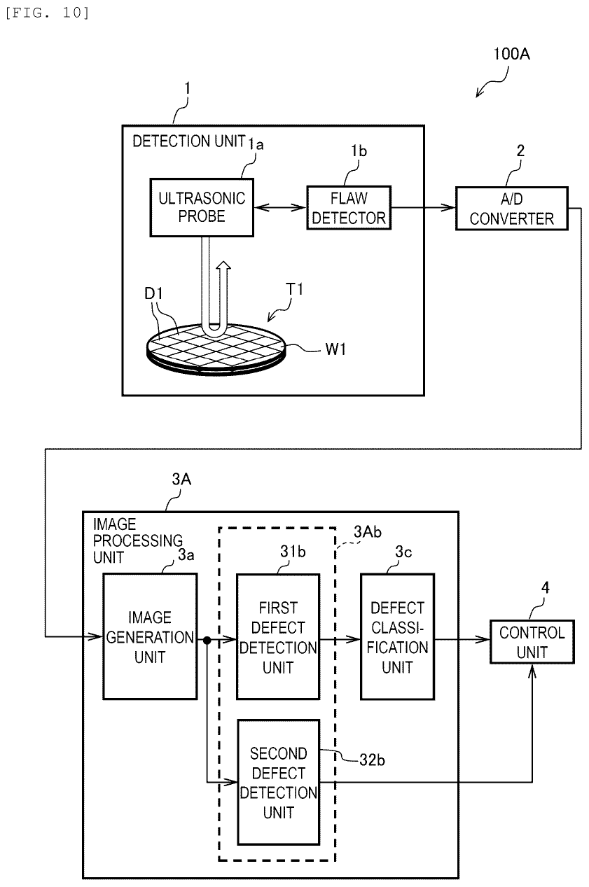

A second embodiment is different from the first embodiment in that a defect detection unit 3Ab (see FIG. 10) includes a first defect detection unit 31b (see FIG. 10) that detects a defect region in a die unit and a second defect detection unit 32b (see FIG. 10) that detects a random defect. Other configurations are the same as those in the first embodiment. Therefore, parts different from those of the first embodiment will be described, and description of repeated parts will be omitted.

FIG. 10 is a diagram illustrating a defect inspection system 100A according to the second embodiment.

As illustrated in FIG. 10, an image processing unit 3A includes the image generation unit 3a, the defect detection unit 3Ab, and a defect classification unit 3Ac. The defect detection unit 3Ab includes the first defect detection unit 31b that detects a defect region for each die D1 and the second defect detection unit 32b that detects a random defect of the inspection object T1.

The processing of the first defect detection unit 31b is the same as the processing of the defect detection unit 3b (see FIG. 1) according to the first embodiment. That is, the first defect detection unit 31b specifies a defect region for each die based on a position, a size, a shape, and luminance of a defect region in addition to die design information. The second defect detection unit 32b detects a random defect such as a void or a crack based on a comparison of luminance for each pixel between the reference image and the die image.

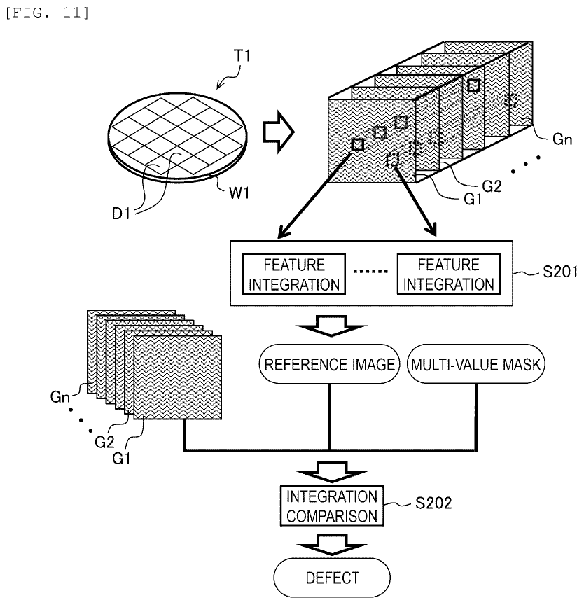

FIG. 11 is a diagram related to processing of the image processing unit (also see FIG. 10 as appropriate).

First, the image processing unit 3A causes the image generation unit 3a to generate an image of the inspection object T1 based on the reflection intensity signal when the inspection object T1 is irradiated with ultrasonic waves. Then, the image processing unit 3A extracts die images of the plurality of dies D1 and aligns the die images. Specifically, the image processing unit 3A makes coordinate values of pixels corresponding to positions common in n die images G1, G2 . . . Gn.

Then, the image processing unit 3A executes feature integration for each pixel of the die image (S201). Here, the “feature integration” is processing of calculating a representative value (for example, a luminance average value or a luminance median value) of n pixels corresponding to positions in n die images G1, G2 . . . Gn. The reference image is generated by executing such feature integration processing for all pixels included in a die image.

The image processing unit 3A generates a multi-value mask illustrated in FIG. 11. The multi-value mask is a dynamic threshold set for each pixel based on a feature of an image, and is set based on predetermined statistical processing. Then, in addition to the die images G1, G2 . . . Gn included in the inspection object T1, the image processing unit 3A executes defect inspection by integration comparison based on the reference image and the multi-value mask (S202). Specifically, the image processing unit 3A causes the second defect detection unit 32b (see FIG. 10) to compare each of the n die images with the reference image. Then, the image processing unit 3A detects a defect of the inspection object T1 based on the multi-value mask which is a dynamic threshold. Accordingly, it is possible to detect a minute defect (random defect such as a void and a crack) that is not detected by the configuration in the first embodiment. The control unit 4 (see FIG. 10) displays a detection result of the second defect detection unit 32b (see FIG. 10) in a predetermined manner on the display device 8 (see FIG. 2).

The image processing unit 3A causes the first defect detection unit 31b (see FIG. 10) or the defect classification unit 3c (see FIG. 10) to execute defect inspection for each die D1 in the inspection object T1. Accordingly, a die defect in the inspection object T1 can also be detected. Since processing of detecting the die defect is the same as that in the first embodiment (see FIG. 6), the description thereof will be omitted.

### Effects

According to the second embodiment, the image processing unit 3A mainly detects a die defect by the first defect detection unit 31b, and detects a random defect by the second defect detection unit 32b. Accordingly, a random defect such as a minute void or crack can be detected with high accuracy in addition to a die defect.

### Third Embodiment

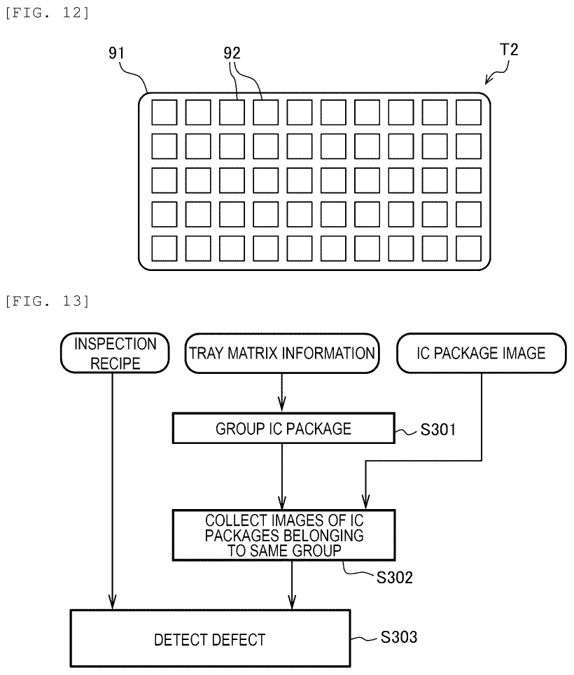

A third embodiment is different from the first embodiment in that a plurality of IC packages 92 (see FIG. 12) placed on an integrated circuit (IC) tray 91 (see FIG. 12) are used as an inspection object T2 (see FIG. 12). The third embodiment is different from the first embodiment in that defect inspection is performed based on a predetermined inspection recipe and tray matrix information. The other configurations (the use of ultrasonic waves, the overall configuration of the defect inspection system 100, and the like: see FIGS. 1 and 2) are the same as those in the first embodiment. Therefore, parts different from those of the first embodiment will be described, and description of repeated parts will be omitted.

FIG. 12 is a plan view illustrating the inspection object T2 in a defect inspection system according to the third embodiment.

As illustrated in FIG. 12, the inspection object T2 has a configuration in which the plurality of IC packages 92 (IC chips serving as dies) are placed on the IC tray 91. The IC tray 91 is provided with a plurality of pockets (reference numerals are not illustrated) in the vertical direction and the horizontal direction. In each pocket, one IC package 92 is placed. The IC package 92 is an electronic component in which a silicon semiconductor on which a predetermined integrated circuit is formed is accommodated in a package. By irradiating such the inspection object T2 with ultrasonic waves, an image of the inspection object T2 is generated.

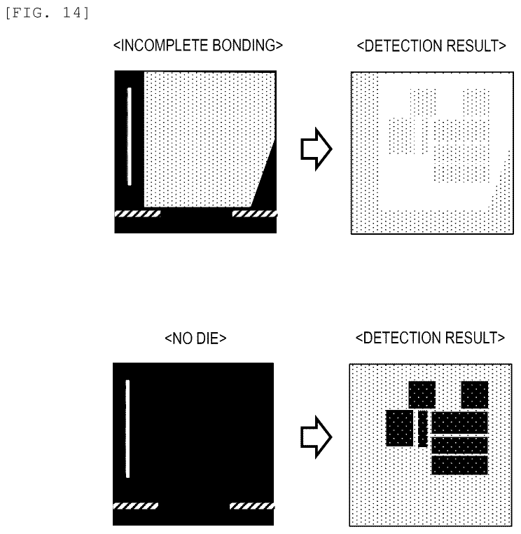

FIG. 13 is a diagram related to processing of an image processing unit (also see FIG. 12 as appropriate).

As illustrated in FIG. 13, defect inspection is performed based on an inspection recipe and tray matrix information in addition to the image (IC package image) of the inspection object T2. The inspection recipe includes, in addition to lengths (the number of pixels) of the IC package 92 in the vertical direction and the horizontal direction in the image of the inspection object T2, an interval (the number of pixels) between the adjacent IC packages 92 in the vertical direction and the horizontal direction, and information on an image of the normal IC package 92. The tray matrix information includes a type, a model number, and identification information of each IC package 92.

Types of the plurality of IC packages 92 placed on the IC tray 91 are not necessarily the same, and different types may be mixed. The defect inspection system 100 (see FIG. 1) groups the plurality of IC packages 92 placed in each pocket of the IC tray 91 for each type (S301).

Then, the defect detection unit 3b (see FIG. 1) collects images of the IC packages 92 belonging to a common group (S302) and performs defect detection (S303). The defect classification unit 3c (see FIG. 1) specifies a defect type in a predetermined defect region for each IC package 92. Accordingly, even when different types of IC packages 92 are mixed in one IC tray 91, the defect inspection can be appropriately performed. Examples of a defect type of the inspection object T2 include “IC missing” in which no IC is included in a package, and “no package” in which no IC package is placed at a certain position. The processing of steps S302 and S303 in FIG. 13 is executed for each group of the IC packages 92.

### Effects

According to the third embodiment, defects of the plurality of IC packages 92 placed on the IC tray 91 can be appropriately inspected. Further, even when different types of IC packages 92 are mixed in one IC tray 91, defect inspection can be individually performed for each type of IC package 92.

### Modification

Although the defect inspection systems 100, 100A according to the invention have been described in the embodiments described above, the invention is not limited thereto, and various changes can be made.

For example, although a case where the image of the inspection object T1 is generated by irradiating the inspection object T1 with the ultrasonic waves has been described in the embodiments, the invention is not limited thereto. That is, the image of the inspection object T1 may be generated based on an X-ray transmission amount when the inspection object T1 is irradiated with X-rays. Since processing contents of the image processing unit 3 (see FIG. 1) in this case are the same as those in the first embodiment and the second embodiment, the description thereof will be omitted.

Although a case where the die design information is created based on the design data of the die D1 has been described in the first embodiment, the invention is not limited thereto. That is, the die design information may be created based on an operation input by a user via an input device (not illustrated). The die design information may be generated based on an ultrasonic wave image of a bonding surface of the inspection object T1. In addition, the inspection object T1 immediately after the semiconductor wafer W1 and the die D1 are bonded may be imaged by an optical microscope (not illustrated), and the die design information may be generated based on that optical image.

Although a case where the position of the die D1, the shape of the die D1, the circuit pattern of the die D1, and the luminance value in the die D1 in a state where the die D1 is appropriately bonded to the semiconductor wafer W1 are included in the die design information (design information) has been described in the first embodiment, the invention is not limited thereto. That is, any one of the position of the die D1, the shape of the die D1, the circuit pattern of the die D1, and the luminance value in the die D1 in a state where the die D1 is appropriately bonded to the semiconductor wafer W1 may be included in the die design information (design information). In this case, the defect classification unit 3c (defect analysis unit) determines the presence or absence of a defect based on whether the matching rate between the reference image and the inspection target image exceeds a threshold for any one piece of the information included in the die design information (design information). For example, in addition to a matching rate related to the position of the die D1 and a matching rate of the shape of the die D1, a matching rate of the circuit pattern of the die D1, and a matching rate of the luminance value in the die D1 in an image are appropriately used as the “matching rate” described above.

Although a case where a feature for each defect type is set in advance has been described in the embodiments, the invention is not limited thereto. For example, a feature for each defect type may be learned based on teaching-learning type deep learning.

Although the circuit structures of the plurality of dies D1 bonded to the semiconductor wafer W1 are common in the first and second embodiments, the invention is not limited thereto. That is, another die having a circuit configuration different from that of the plurality of dies D1 may be mixed in the semiconductor wafer W1. In this case, defect inspection is performed for each die D1 of the same type.

The processing of determining a defect type is not limited to that described in the embodiments. For example, in a case where a defect type in a defect region is a random defect, when the average luminance of the defect region is less than the fifth predetermined value, the defect classification unit 3c (see FIG. 1) may determine that the random defect is a defect in the circuit pattern of the die D1. This is because the ultrasonic waves are less likely to be reflected at a portion where the circuit pattern of the die D1 is defective, and luminance on an image decreases.

In a case where a defect type in a defect region is a random defect, when the average luminance of the defect region is equal to or larger than the fifth predetermined value, the defect classification unit 3c (see FIG. 1) may determine that the random defect is a void or a crack. This is because the ultrasonic waves are reflected at an interface of a gap (the void or the crack) between the semiconductor wafer W1 and the die D1, and luminance on an image becomes relatively high. In this case, the defect classification unit 3c (see FIG. 1) may also determine the presence or absence of a void or a crack in a die image of another adjacent die across a side overlapping the void or the crack among sides constituting a contour of the die image. Accordingly, overlooking of a void or a crack in the inspection object T1 can be prevented.

Although a case where an inspection object is formed by die-to-wafer bonding has been described in the first and second embodiments, the invention is not limited thereto. For example, the first and second embodiments can also be applied to a substrate having a multilayer structure such as a micro electro mechanical (MEMS) wafer.

Although defect inspection of the inspection object T2 having a configuration in which the IC packages 92 (IC chips serving as dies: see FIG. 12) are placed in pockets of the IC tray 91 in a one-to-one manner (see FIG. 12) has been described in the third embodiment, the invention is not limited thereto. For example, the third embodiment can also be applied to defect inspection of an IC package (IC chip serving as a die) on a strip substrate (not illustrated). In addition, the third embodiment can also be applied to defect inspection of various inspection objects having a configuration in which a predetermined electronic component is placed on a plate-shaped body.

The embodiments can be combined as appropriate. For example, the first embodiment and the second embodiment may be combined, and when the pattern matching rate is equal to or less than the predetermined value P1 in step S108 of FIG. 6 (S108: No), the integration comparison processing in the second embodiment (S202 of FIG. 11) may be executed. The integration comparison processing (S202 in FIG. 11) may be executed on a die image in which no die defect is detected.

Further, a program executed by the defect inspection systems 100, 100A (a program for a defect inspection method or the like) can be provided via a communication line, or can be written in a recording medium such as a CD-ROM and distributed.

Further, the embodiments have been described in detail to describe the disclosure in an easy-to-understand manner, and the invention is not necessarily limited to those including all the configurations described above. In addition, another configuration can be added to, deleted from, or replaced with a part of configurations according to one embodiment.

Mechanisms and configurations described above indicate what is considered to be necessary for explanation, and not all mechanisms and configurations are necessarily illustrated on a product.

### REFERENCE SIGNS LIST

1: detection unit
2: A/D converter
3, 3A: image processing unit
3a: image generation unit (inspection image acquisition unit)
3b, 3Ab: defect detection unit (defect region detection unit)
3c: defect classification unit (defect analysis unit)
4: control unit
31b: first defect detection unit
32b: second defect detection unit
91: IC tray
92: IC package (die, IC chip)
100, 100A: defect inspection system
D1: die
T1, T2: inspection object
W1: semiconductor wafer

1. A defect inspection system comprising:
an inspection image acquisition unit configured to acquire an inspection target image by irradiating an inspection object formed by bonding a die to a semiconductor wafer with ultrasonic waves or X-rays;
a defect region detection unit configured to detect a defect region by comparing a reference image indicating an image in which the die is appropriately bonded to the semiconductor wafer with the acquired inspection target image; and
a defect analysis unit configured to determine presence or absence of a defect in a die unit by analyzing the defect region with reference to design information of the die.

2. The defect inspection system according to claim 1, wherein
the design information includes any one of a position of the die, a shape of the die, a circuit pattern of the die, and a luminance value in the die in a state where the die is appropriately bonded to the semiconductor wafer.

3. The defect inspection system according to claim 2, wherein
the defect in the die unit is a defect caused by a bonding error between the die and the semiconductor wafer.

4. The defect inspection system according to claim 2, wherein
the defect in the die unit includes any one of a case where the die is missing on the semiconductor wafer, a case where the die is bonded to the semiconductor wafer in a distorted state, a case where a part of the die is not bonded to the semiconductor wafer, a case where the die is bonded to the semiconductor wafer in a floating state, a case where there is a gap between the die and the semiconductor wafer, a case where there is a foreign substance between the die and the semiconductor wafer, and a case where a bonding position of the die on the semiconductor wafer is not appropriate.

5. The defect inspection system according to claim 3, wherein
the defect analysis unit determines presence or absence of a defect caused by a void or a crack in addition to the defect in the die unit.

6. The defect inspection system according to claim 4, wherein
the defect analysis unit determines presence or absence of a defect caused by a void or a crack in addition to the defect in the die unit.

7. The defect inspection system according to claim 2, wherein
the defect analysis unit determines presence or absence of a defect based on whether a matching rate between the reference image and the inspection target image exceeds a threshold for any information included in the design information.

8. The defect inspection system according to claim 1, wherein
the inspection object is a hybrid bonding semiconductor wafer in which an electrode formed on a surface of the semiconductor wafer is bonded to an electrode formed on a surface of the die.

9. The defect inspection system according to claim 1, wherein
the die is an IC chip.

10. A defect inspection method comprising:
inspection image acquisition processing of acquiring an inspection target image by irradiating an inspection object formed by bonding a die to a semiconductor wafer with ultrasonic waves or X-rays;
defect region detection processing of detecting a defect region by comparing a reference image indicating an image in which the die is appropriately bonded to the semiconductor wafer with the acquired inspection target image; and
defect analysis processing of determining presence or absence of a defect in a die unit by analyzing the defect region with reference to design information of the die.
